(19) United States
(12) Patent Application Publication
(10) Pub. No.: US 2017/0289787 A1
(43) Pub. Date: Oct. 5, 2017

(54) BLUETOOTH-BASED METHOD AND SYSTEM FOR AUTOMATICALLY CONNECTING WEARABLE DEVICE WITH MOBILE TERMINAL

(71) Applicant: HUIZHOU TCL MOBILE COMMUNICATION CO., LTD., Huizhou City (CN)

(72) Inventors: Longjie Yu, Huizhou (CN); Xianghui Lou, Huizhou (CN)

(21) Appl. No.: 15/503,713

(22) PCT Filed: Jul. 6, 2016
(86) PCT No.: PCT/CN2016/088838

§ 371 Date: Feb. 14, 2017

(30) Foreign Application Priority Data
Dec. 2, 2015 (CN) 201510872349.9

(51) Int. Cl. H04W 8/00; H04W 76/02

(52) U.S. Cl. CPC H04W 8/005; H04W 76/023

(57) ABSTRACT

A Bluetooth-based method and system for automatic connection between a wearable device and a mobile terminal is described. The wearable device advertises a Bluetooth name; the smart terminal acquires the Bluetooth name of the wearable device, and when the Bluetooth name exists in a Bluetooth name list of the smart terminal, the smart terminal may write the Bluetooth name of the wearable device into a scan list. When the wearable device is placed in a specific area of the smart terminal, which may be determined according to a received signal strength indication (RSSI) threshold, the wearable device is automatically connected, which not only has a convenient operation, but also ensures security.

### TECHNICAL FIELD

The present invention relates to the field of Bluetooth technologies, and in particular to a Bluetooth-based method and system for automatic connection between a wearable device and a mobile terminal.

### BACKGROUND

Currently, there are numerous wearable devices available on the market, which have been accepted and used by users, such as smart watches, smart bands, smart glasses, smart running shoes, smart rings, and the like. These wearable devices are connected to cell phones substantially via Bluetooth, and when a user installs a corresponding application on the cell phone, different services can be provided. For example, a user answers phone calls, receives messages, and remotely controls photo-taking via a smart watch; detects his/her own health conditions, including calorie consumption, heartbeat, and blood pressure level, via a smart band; assists teaching via a pair of smart glasses; records exercise tracks and running distance in kilometer via a pair of smart running shoes; and detects sleep statuses via a smart ring. In a practical application scenario when a user connects a cell phone with a wearable device via Bluetooth, the user is typically required to manually click scanning, connection request, and confirmation operations on the cell phone, and a confirmation operation on the wearable device, leading to the inconvenient use.

Therefore, connection to wearable devices still needs improvement.

### SUMMARY

A Bluetooth-based method and system for automatic connection between a wearable device and a mobile terminal is provided, and intends to solve the problem of the prior art that, when a user connects a smart terminal with a wearable device via Bluetooth, the user is typically required to manually click scanning, connection request, and confirmation operations on the cell phone, and a confirmation operation on the wearable device, leading to the inconvenient use.

In an embodiment, a Bluetooth-based method for automatic connection between a wearable device and a mobile terminal is provided, wherein the method comprises:

The wearable device advertises a Bluetooth name via Bluetooth;

The smart terminal scans to acquire the Bluetooth name of the wearable device, and when the Bluetooth name exists in a Bluetooth name list pre-written into the smart terminal, writes the Bluetooth name of the wearable device into a scan list;

Detecting current Bluetooth received signal strength indication values of the Bluetooth signals transmitted by the wearable devices that have been written into the scan list;

The smart terminal acquires a current Bluetooth received signal strength indication value that corresponds to each wearable device in the scan list, and if the current Bluetooth received signal strength indication value of a wearable device is higher than a preset Bluetooth received signal strength indication threshold, establishes a Bluetooth connection with the corresponding wearable device.

In a further embodiment, the Bluetooth-based method for automatic connection between a wearable device and a mobile terminal, wherein the wearable device advertises a Bluetooth name in a Bluetooth mode and transmits a Bluetooth signal; wherein the Bluetooth mode is a mode that supports Bluetooth 2.0, Bluetooth 2.1 or Bluetooth 3.0.

In a further embodiment, the Bluetooth-based method for automatic connection between a wearable device and a mobile terminal, wherein the wearable device advertises a Bluetooth name in a Bluetooth Low Energy mode and transmits a Bluetooth signal; wherein the Bluetooth Low Energy mode is a mode that supports Bluetooth Smart.

In a further embodiment, the Bluetooth-based method for automatic connection between a wearable device and a mobile terminal, wherein the Bluetooth received signal strength indication threshold is −30 dBm.

In an embodiment, a Bluetooth-based method for automatic connection between a wearable device and a mobile terminal is provided, wherein the method comprises:

The wearable device advertises a Bluetooth name via Bluetooth;

The smart terminal scans to acquire the Bluetooth name of the wearable device, and when the Bluetooth name exists in a Bluetooth name list pre-written into the smart terminal, writes the Bluetooth name of the wearable device into a scan list.

The Bluetooth-based method for automatic connection between a wearable device and a mobile terminal, wherein, after the step of writing the Bluetooth name of the wearable device into a scan list, it further comprises:

The smart terminal acquires a current Bluetooth received signal strength indication value that corresponds to each wearable device in the scan list, and if the current Bluetooth received signal strength indication value of a wearable device is higher than a preset Bluetooth received signal strength indication threshold, establishes a Bluetooth connection with the corresponding wearable device.

In a further embodiment, the Bluetooth-based method for automatic connection between a wearable device and a mobile terminal, wherein the wearable device advertises a Bluetooth name in a Bluetooth mode and transmits a Bluetooth signal; wherein the Bluetooth mode is a mode that supports Bluetooth 2.0, Bluetooth 2.1 or Bluetooth 3.0.

In a further embodiment, the Bluetooth-based method for automatic connection between a wearable device and a mobile terminal, wherein the wearable device advertises a Bluetooth name in a Bluetooth Low Energy mode and transmits a Bluetooth signal; wherein the Bluetooth Low Energy mode is a mode that supports Bluetooth Smart.

In a further embodiment, the Bluetooth-based method for automatic connection between a wearable device and a mobile terminal, wherein, after the step of writing the Bluetooth name of the wearable device into a scan list, it further comprises:

Detecting current Bluetooth received signal strength indication values of the Bluetooth signals transmitted by the wearable devices that have been written into the scan list.

The Bluetooth-based method for automatic connection between a wearable device and a mobile terminal, wherein the Bluetooth received signal strength indication threshold is −30 dBm.

In an embodiment, a Bluetooth-based system for automatic connection between a wearable device and a mobile terminal, wherein the system comprises:

A Bluetooth advertising module configured for a wearable device to advertise a Bluetooth name via Bluetooth;

A scanning module configured for a smart terminal to scan to acquire the Bluetooth name of the wearable device, and when the Bluetooth name exists in a Bluetooth name list pre-written into the smart terminal, to write the Bluetooth name of the wearable device into a scan list.

In a further embodiment, the Bluetooth-based system for automatic connection between a wearable device and a mobile terminal, wherein the system further comprises:

A Bluetooth connection module configured for a smart terminal to acquire a current Bluetooth received signal strength indication value that corresponds to each wearable device in the scan list, and if the current Bluetooth received signal strength indication value of a wearable device is higher than a preset Bluetooth received signal strength indication threshold, to establish a Bluetooth connection with the corresponding wearable device.

In a further embodiment, the Bluetooth-based system for automatic connection between a wearable device and a mobile terminal, wherein the wearable device in the Bluetooth advertising module advertises a Bluetooth name in a Bluetooth mode and transmits a Bluetooth signal; wherein the Bluetooth mode is a mode that supports Bluetooth 2.0, Bluetooth 2.1 or Bluetooth 3.0.

In a further embodiment, the Bluetooth-based system for automatic connection between a wearable device and a mobile terminal, wherein the wearable device in the Bluetooth advertising module advertises a Bluetooth name in a Bluetooth Low Energy mode and transmits a Bluetooth signal; wherein the Bluetooth Low Energy mode is a mode that supports Bluetooth Smart.

In a further embodiment, the Bluetooth-based system for automatic connection between a wearable device and a mobile terminal, wherein the scanning module is further configured to detect current Bluetooth received signal strength indication values of the Bluetooth signals transmitted by the wearable devices that have been written into the scan list.

In a further embodiment, the Bluetooth-based system for automatic connection between a wearable device and a mobile terminal, wherein the Bluetooth received signal strength indication threshold is −30 dBm.

Thus, a Bluetooth-based method and system for automatic connection between a wearable device and a mobile terminal is provided. When the wearable device is placed within a specific area of the smart terminal, the wearable device can be automatically connected, which not only has a convenient operation, but also ensures security.

### BRIEF DESCRIPTION OF THE DRAWINGS

FIG. 1 depicts a flow chart of a Bluetooth-based method for automatic connection between a wearable device and a mobile terminal, according to a preferred exemplary embodiment of the present invention.

FIG. 2 depicts a schematic diagram of a relation of Bluetooth RSSI signal value vs. distance between a smart phone and a smart watch.

FIG. 3 depicts a schematic diagram of 6 different testing positions where a smart watch is placed when the screen of the smart watch is placed against the screen of a smart phone.

FIG. 4 depicts a schematic diagram of a relation of Bluetooth RSSI signal value vs. distance when a smart phone and a smart watch have their screens against each other.

FIG. 5 depicts a structural block diagram of a Bluetooth-based system for automatic connection between a wearable device and a mobile terminal, according to a preferred exemplary embodiment of the present invention.

### DETAILED DESCRIPTION

To make the objects, technical solutions and advantages of the present invention clearer and more specific, the present invention will be further described in detail below with reference to the accompanying drawings and specific embodiments. It should be understood that the specific embodiments described herein are only used to explain the present invention, and not used to limit the present invention.

First, the Bluetooth Low Energy protocol will be described in detail below.

Compared with the conventional Bluetooth, Bluetooth Low Energy (BLE) has the biggest advantage in its energy saving and relatively small quantity of transmitted data, making it applicable for wireless service connection between smart terminals. The development of Bluetooth Low Energy protocols is mainly on the Link Layer (LL), Generic Access Profile (GAP) and Generic Attribute Profile (GATT).

According to the Bluetooth 4.0 protocol issued by the Bluetooth SIG, the Link Layer defines signaling of BLE channel, Advertiser (Broadcaster), Scanner and Initiator in the non-connection state.

Specifically, the signaling format of a BLE channel is shown in Table 1, which is applicable for both broadcasting channels and data channels, wherein the Preamble and Access Address are both fixed data for the BLE channel, the Protocol Data Unit (PDU) may carry information in the BLE channel, and CRC is used for cyclic check.

TABLE 1

| Preamble | Access Address | PDU | CRC |
|---|---|---|---|
| 1 Byte | 4 Bytes | 2 to 39 Bytes | 3 Bytes |

With respect to the signaling format of a broadcasting channel, a PDU (Protocol Data Unit) consists of Header and Payload, as shown in Table 2, and Table 2 shows the PDU format of a broadcasting channel.

The 4-bit PDU Type in the Header determines the type of signaling, e.g. connectable undirected advertising signaling (ADV_IND), connectable directed advertising signaling (ADV_DIRECT_IND), non-connectable undirected advertising signaling (ADV_NONCONN_IND), scan request signaling (SCAN_REQ), scan response signaling (SCAN_RSP), connection request signaling (CONNECT_REQ), and scannable undirected advertising signaling (ADV_SCAN_IND), see Table 3 for details.

TABLE 3

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Wherein, when an advertiser (broadcaster) sends connectable undirected advertising signaling (ADV_IND) to a scanner, the Payload format of the connectable undirected advertising signaling (ADV_IND) is shown in Table 4. Wherein, AdvA represents the Bluetooth address of the advertiser (broadcaster), and AdvData represents the advertising data package, which can carry at most messages of 31 bytes.

TABLE 4
Payload

| AdvA | AdvData |
|---|---|
| 6 Bytes | 0-31 Bytes |

The format of AdvData (advertising data package) of ADV_IND (connectable undirected advertising signaling) is shown in Table 5. Wherein, AD Structure represents a message segment, and one advertising data package may contain multiple message segments; AD Type the type of a message segment, e.g. Bluetooth name, Bluetooth manufacturer, UUID, etc.; AD Data represents content of a message segment; the value of Length represents the total number of bytes of the type of the message segment and the content of the message segment.

The AD Type field that has been defined by the Bluetooth SIG is shown in Table 6, and the undefined is a reserved field.

TABLE 6

| | | | | | | | |
|---|---|---|---|---|---|---|---|
| 0 × 01 | 0 × 02 | 0 × 03 | 0 × 04 | 0 × 05 | 0 × 06 | 0 × 07 | 0 × 08 |
| 0 × 09 | 0 × 0A | 0 × 0D | 0 × 0E | 0 × 0F | 0 × 10 | 0 × 11 | 0 × 12 |
| 0 × 14 | 0 × 1F | 0 × 15 | 0 × 16 | 0 × 20 | 0 × 21 | 0 × 17 | 0 × 18 |
| 0 × 19 | 0 × 1A | 0 × 1B | 0 × 1C | 0 × 1D | 0 × 1E | 0 × 3D | 0 × FF |

The Link Layer defines 3 roles in a broadcasting channel: Advertiser (Broadcaster), Scanner and initiator. The Link Layer defines 3 states in a broadcasting channel: Advertising State, Scanning State and Initiating State.

Wherein, the Advertising State may be divided into:

1) Connectable undirected event: an Advertiser (Broadcaster) advertises ADV_IND signaling to all surrounding Scanners, and announces that it is in a connectable mode. The Advertiser (Broadcaster) monitors the SCAN_REQ signaling sent from the Scanners, and sends SCAN_RSP signaling to the Scanners. The Advertiser (Broadcaster) also monitors the CONNECT_REQ signaling sent from Initiators;

2) Connectable directed event: an Advertiser (Broadcaster) advertises ADV_DIRECT_IND signaling to specific surrounding Scanners, and announces that it is in a connectable mode. The Advertiser (Broadcaster) only monitors the CONNECT_REQ signaling sent from specific Initiators;

3) Non-connectable undirected event: an Advertiser (Broadcaster) advertises ADV_NONCONN_IND signaling to all surrounding Scanners, and announces that it is in a non-connectable mode. The Advertiser (Broadcaster) does not monitor signaling sent from Scanners;

4) Scannable undirected event: an Advertiser (Broadcaster) advertises ADV_SCAN_IND signaling to all surrounding Scanners. The Advertiser (Broadcaster) only monitors SCAN_REQ signaling sent from Scanners, and then sends a SCAN_RSP signaling to the Scanners.

The Scanning State may be divided into:

1) Passive scanning: a Scanner in the passive scanning mode can only monitor signaling advertised by an Advertiser (Broadcaster), and cannot send data externally;

2) Active scanning: a Scanner in the active scanning mode monitors signaling advertised by an Advertiser (Broadcaster), only sends SCAN_REQ signaling to an Advertiser (Broadcaster) that advertises the ADV_IND signaling and ADV_SCAN_IND signaling, and when the sending is completed, continues to monitors SCAN_RSP signaling from the Advertiser (Broadcaster).

In the Initiating State:

An Initiators in the Initiating State may send CONNECT_REQ signaling to an Advertiser (Broadcaster) that advertises the ADV_IND signaling and ADV_DIRECT_IND signaling.

Signaling relations corresponding to three states of a broadcasting channel, Advertising State, Scanning State and Initiating State, are shown in Table 7.

TABLE 7

| | | Response PDU for advertising event | |
|---|---|---|---|
| Advertising event | PDU in advertising event | SCAN_REQ | CONNECT_REQ |
| Connectable undirected event | ADV_IND | YES | YES |
| Connectable directed event | ADV_DIRECT_IND | NO | YES |
| Non-connectable undirected event | ADV_NONCONN_IND | NO | NO |
| Scannable undirected event | ADV_SCAN_IND | YES | NO |

4 roles are defined in the GAP layer: Advertiser (Broadcaster) Role, Observer Role, Peripheral Role and Central Role.

1) Broadcaster Role: a device in the Broadcaster Role advertises to the surrounding in a low energy mode, but does not respond to connection requests sent from other devices, i.e. a device in the Advertiser (Broadcaster) Role is in a non-connectable mode;

2) Observer Role: a device in the Observer Role can scan devices in the Advertiser (Broadcaster) Role, but cannot initiate a connection request, i.e. a device in the Observer Role is in a non-connectable mode;

3) Peripheral Role: a device in the Peripheral Role advertises to the surrounding in a low energy mode, and responds to connection requests sent from other devices, i.e. a device in the Peripheral Role is in a connectable mode;

4) Central Role: a device in the Central Role can scan devices in the Peripheral Role, and can initiate a connection request, i.e. a device in the Central Role is in a connectable mode.

The correspondence between LL and GAP is shown in Table 8, wherein “E” represents no support, “M” represents must support, “O” represents selective support, and “O/E” represents that, if a Central Role supports passive scanning, then the Central Role selects to support active scanning, otherwise the Central Role must support active scanning.

TABLE 8

| Link Layer functionality | Broadcaster | Observer | Peripheral | Central |
|---|---|---|---|---|
| Advertising event types: | | | | |
| Connectable undirected | E | E | M | E |
| event | | | | |
| Connectable directed | E | E | O | E |
| event | | | | |
| Non-connectable | M | E | O | E |
| undirected event | | | | |
| Scannable undirected | O | E | O | E |
| event | | | | |
| Scanning types: | | | | |
| Passive scanning | E | M | E | O |
| Active scanning | E | O | E | O/E |

Subsequently, the conventional Bluetooth protocol will be described in detail below.

The conventional Bluetooth has advantages of relatively high transmission data quantity and relatively quick data transmission rate, which is applicable for various practical applications. The development of conventional Bluetooth is mainly on Logical Link Control and Adaptation Protocol (L2CAP), Generic Access Profile (GAP) and Application Profile, which will be introduced, respectively, below.

According to the conventional Bluetooth protocol issued by the Bluetooth SIG, the Logical Link Control and Adaptation Protocol (L2CAP) defines command format and data format.

Two Bluetooth devices need to exchange a series of commands in the communication process, the general signaling format of a command channel is shown in Table 9.

TABLE 9

| | | Commands | | | |
|---|---|---|---|---|---|
| Length | Channel ID | Code | Identifier | Length | Data |
| m + 4 | 0001 | | | m | |
| 2 Bytes | 2 Bytes | 1 Byte | 1 Byte | 2 Bytes | m Bytes |

Wherein, Length represents the byte length of Commands; Channel ID is fixed to be 0x0001; Code in Commands represents a type of a command, such as connection request and connection response, as shown in Table 10; Identifier in Commands is used to match a request and a response; Length in Commands represents the byte length of Data in Commands; Data in Commands represents information that a command can carry.

TABLE 10

| Code | Description |
|---|---|
| 0x00 | RESERVED |
| 0x01 | Command reject |
| 0x02 | Connection request |
| 0x03 | Connection response |
| 0x04 | Configure request |
| 0x05 | Configure response |
| 0x06 | Disconnection request |
| 0x07 | Disconnection response |
| 0x08 | Echo request |
| 0x09 | Echo response |
| 0x0A | Information request |
| 0x0B | Information response |

The Commands format of connection request is shown in Table 11. Wherein, PSM represents protocol/service multiplexer, which is divided into two parts, the first part is fixedly allocated by the Bluetooth SIG to be used as protocol, and the second part is dynamically allocated by the system to be used as service, which at least takes up a length of 2 bytes; Source CID (source channel ID) represents channel ID of a Bluetooth device that sends a connection request.

TABLE 11

Data

| Code | Identifier | Length | PSM | Source CID |
|---|---|---|---|---|
| 02 | | m + 2 | | |
| 1 Byte | 1 Byte | 2 Bytes | m(≧2) Bytes | 2 Bytes |

The Commands format of connection response is shown in Table 12.

TABLE 12

| | | | Data | | | |
|---|---|---|---|---|---|---|
| | | | Destination | Source | | |
| Code | Identifier | Length | CID | CID | Result | Status |
| 03 | | S | | | | |
| 1 Byte | 1 Byte | 2 Bytes | 2 Bytes | 2 Bytes | 2 Bytes | 2 Bytes |

Wherein, Destination CID (destination channel ID) represents channel ID of a Bluetooth device that sends a connection response; Source CID (source channel ID) represents channel ID of a Bluetooth device that receives the connection response, and it is directly copied from the Source CID in the connection request command; Result represents a result of the connection request signaling, for example, Connection successful, Connection pending, and Connection refused, as shown in Table 13;

TABLE 13

| Value | Description |
|---|---|
| 0x0000 | Connection successful |
| 0x0001 | Connection pending |
| 0x0002 | Connection refused - PSM not supported |
| 0x0003 | Connection refused - security block |
| 0x0004 | Connection refused - no resources available |
| Other | Reserved |

In the situation where the result of the connection request signaling is pending, Status is used to further describe the reason why the result is pending, as shown in Table 14.

TABLE 14

| Value | Description |
|---|---|
| 0x0000 | Connection successful |
| 0x0001 | Connection pending |
| 0x0002 | Connection refused - PSM not supported |
| 0x0003 | Connection refused - security block |
| 0x0004 | Connection refused - no resources available |
| Other | Reserved |
| 0x0000 | No further information available |
| 0x0001 | Authentication pending |
| 0x0002 | Authorization pending |
| Other | Reserved |

Generic Access Profile (GAP) defines statuses and flows, such as inquire, discoverable, connection, connectable, and connected.

By means of time division multiplexing, a Bluetooth device can simultaneously inquire Bluetooth devices nearby and be discovered by Bluetooth devices nearby, namely a conventional Bluetooth device can act simultaneously as an inquiring device and a discoverable device. The inquiring device obtains Bluetooth addresses of discoverable devices through inquiry.

An inquiring device and a discoverable device may probably be already in a connected state with another Bluetooth device, but still keep functions of inquiring and being discoverable.

By means of time division multiplexing, a Bluetooth device can simultaneously connect Bluetooth devices nearby and be connected by Bluetooth devices nearby, namely the Bluetooth device can act simultaneously as a connecting device and a connectable device. The connecting device sends a Connection Request to a connectable device; the connectable device sends a Connection Response to the connecting device. When the connection is successful, the Bluetooth device that initiates connection becomes Master in the network, and the connected Bluetooth device becomes Slave in the network.

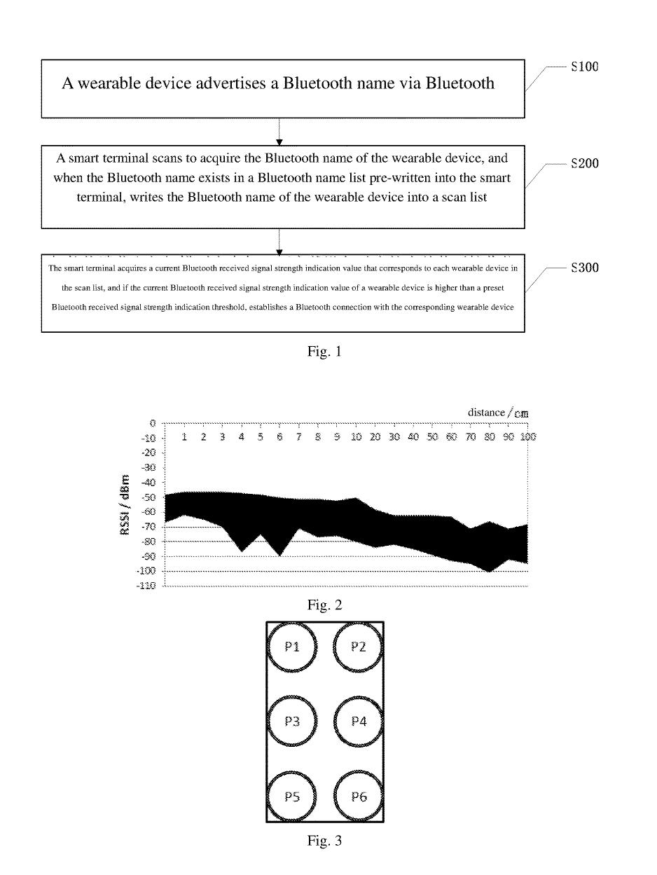

By combining characteristics of Bluetooth Low Energy and conventional Bluetooth, the present invention provides a Bluetooth-based method for automatic connection between a wearable device and a mobile terminal. Referring to FIG. 1, FIG. 1 is a flow chart of a preferred embodiment of a Bluetooth-based method for automatic connection between a wearable device and a mobile terminal according to the present invention. As shown in FIG. 1, the Bluetooth-based method for automatic connection between a wearable device and a mobile terminal comprises the following:

The wearable device advertises a Bluetooth name via Bluetooth; (Block S100)

The smart terminal scans to acquire the Bluetooth name of the wearable device, and when the Bluetooth name exists in a Bluetooth name list pre-written into the smart terminal, writes the Bluetooth name of the wearable device into a scan list. (Block S200)

In an embodiment of the present invention, the wearable device in Block S100 advertises a Bluetooth name in a Bluetooth mode (i.e. in the conventional Bluetooth mode) or in a Bluetooth Low Energy mode, and transmits a Bluetooth signal; wherein the Bluetooth mode is a mode that supports Bluetooth 2.0, Bluetooth 2.1 or Bluetooth 3.0; the Bluetooth Low Energy mode is a mode that supports Bluetooth Smart. In specific implementation, the wearable device is a smart watch, a smart band, a pair of smart glasses, a pair of smart running shoes, or a smart ring. The smart terminal is a terminal that carries an operating system, such as a smart phone, a tablet computer, a laptop computer or a desktop computer.

In a specific implementation, Block S100 and Block S200 are specifically described with the smart terminal being a smart phone. The wearable device advertises a predefined Bluetooth name via Bluetooth, and simultaneously transmits a Bluetooth signal; the smart phone scans (inquires), via Bluetooth, surrounding Bluetooth devices, and filters out a wearable device having the same Bluetooth name as the one in a Bluetooth name list that has been pre-written into the smart terminal, and simultaneously detects RSSI (Received Signal Strength Indication) of the Bluetooth signal of the corresponding wearable device. The Bluetooth functions and flows defined herein are applicable for the Bluetooth Low Energy mode and the conventional Bluetooth mode, which will be described below, respectively.

If both the wearable device and the smart phone support the Bluetooth Low Energy mode, the wearable device advertises in the Bluetooth Low Energy mode, and the 31-byte advertising data package carries a Bluetooth name message segment with AD Type being 0x09. The Bluetooth name is pre-written into APP applications installed on the smart phone, consequently when the smart phone is passively scanning surrounding Bluetooth Low Energy devices, it will filter out wearable devices from the obtained scanning results, according to the pre-written Bluetooth name, having the same Bluetooth name as the pre-written Bluetooth name, and obtain a scan list.

If both the wearable device and the smart phone support the conventional Bluetooth, the wearable device is in a discoverable mode and advertises the Bluetooth name. The Bluetooth name is pre-written into APP applications installed on the smart phone, consequently when the smart phone is inquiring surrounding conventional Bluetooth devices, it will filter out wearable devices from the obtained inquiring results, according to the pre-written Bluetooth name, having the same Bluetooth name as the pre-written Bluetooth name, and form an inquiring list (to be consistent with Bluetooth Low Energy, the “inquiring list” herein is also referred to as the “scan list”).

Furthermore, as shown in FIG. 1, after Block S200, The smart terminal acquires a current Bluetooth received signal strength indication value that corresponds to each wearable device in the scan list, and if the current Bluetooth received signal strength indication value of a wearable device is higher than a preset Bluetooth received signal strength indication threshold, establishes a Bluetooth connection with the corresponding wearable device. In a specific implementation, the Bluetooth received signal strength indication threshold is −30 dBm. (Block S300)

Furthermore, Block S200 further comprises the smart terminal detecting current Bluetooth received signal strength indication values of the Bluetooth signals transmitted by the wearable devices that have been written into the scan list.

A wearable device advertises a specific Bluetooth name and transmits a Bluetooth signal; a smart terminal scans (inquires) wearable devices having the specific Bluetooth name, and detects Bluetooth signals of these wearable devices to acquire Bluetooth RSSI signal values. Theoretically, Bluetooth RSSI signal value decreases as the distance between two Bluetooth devices increases; in practice, RSSI signal value has a decreasing trend as the distance between two Bluetooth devices increases, but such a rule is not followed in some individual special circumstances. In other words, the RSSI signal value of two devices having a distance is greater than the RSSI signal value of two devices having a shorter distance. As a result, a wave band, rather than a slanted line of a linear function, will be formed. FIG. 2 is a schematic diagram of a relation of Bluetooth RSSI signal value vs. distance between a smart phone and a smart watch. The testing environment of FIG. 2 is as follows: a smart watch transmits a Bluetooth signal, a smart phone detects the Bluetooth signal from the smart watch at different positions at the same distance from the watch (a total of 10 horizontal and vertical positions), and acquires RSSI signal values. At each distance, the cell phone detects a total of 10 RSSI signal values, and forms a RSSI wave band by taking the maximum and minimum of the 10. Subsequently, it detects at 20 different distances sequentially from 0 cm to 100 cm. It can be seen from FIG. 2 that the RSSI wave band does not have a significant decreasing trend as the distance increases, and the RSSI wave band is relatively wide.

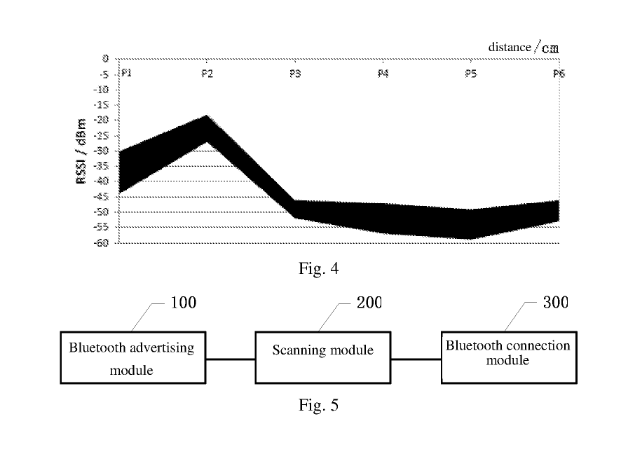

A wearable device advertises a specific Bluetooth name and transmits a Bluetooth signal; a smart terminal scans wearable devices having the specific Bluetooth name, and detects Bluetooth signals of the wearable devices to acquire Bluetooth RSSI signal values. When the screen of a wearable device gets close to a specific position of the screen of the smart terminal, the RSSI signal of the wearable device detected by the smart terminal will be significantly high. FIG. 3 shows testing situations in which a smart watch is placed at different positions when its screen is placed against the screen of a smart phone. The testing environment of FIG. 3 is as follows: a smart watch and a smart phone are placed with their screens against each other, the smart watch is placed at 6 different positions of the screen of the smart phone, which are P1, P2, P3, P4, P5 and P6. The smart watch transmits a Bluetooth signal, and the smart phone detects the Bluetooth signal from the smart watch and acquires RSSI signal values. At each position, the cell phone detects a total of 10 Bluetooth RSSI signal values, and forms a RSSI wave band by taking the maximum and minimum of the 10. FIG. 4 is a schematic diagram of a relation of Bluetooth RSSI signal value vs. distance when a smart phone and a smart watch have their screens against each other.

It can be seen from FIG. 4 that, when the smart watch has its screen against the screen of the smart phone and is at the P2 position, the RSSI signal wave band value detected by the cell phone is significantly higher than those at the other 5 positions, and significantly higher than the entire RSSI signal wave band value in the relation of Bluetooth RSSI signal value vs. distance in FIG. 2. As a matter of fact, when the screen of the smart watch approaches the P2 position of the screen of the smart phone, the distance between the antennas of the two Bluetooth devices is the shortest. In such a circumstance, the Bluetooth RSSI signal detection threshold at the side of the smart phone may be set to −30 dBm, i.e., only when the Bluetooth RSSI signal value of a wearable device detected by the smart phone is higher than the threshold, will the smart phone connects to the wearable device via Bluetooth.

With respect to the curve in FIG. 4, only one of existing numerous models of smart phones is selected and only one of existing numerous models of smart watches is selected for the testing. It can be seen that, when other models of smart phones are used to test the same wearable device, the position of the highest Bluetooth RSSI signal value may not necessarily be at P2. In light of such a situation, an APP version may be upgraded, i.e. to test main models of smart phones on the market are tested first to determine circular area positions corresponding to the highest Bluetooth RSSI signal values, and then to integrate them into the same APP. When a user opens the APP, the APP displays different circular area positions according to the hardware versions of the smart phones, such that the user follows the prompt to operate. In such a way, the compatibility issue among different cell phones can be solved. Throughout the entire process, the user operations are convenient, no manual settings are required, and a variety of smart terminal models are compatible.

For a user, when the user opens an APP corresponding to a wearable device, the APP will display a specific circular area position on the screen, and prompt the user to move the screen of the wearable device closer to the circular area. The APP of the smart phone automatically scans (inquires) wearable devices having a specific Bluetooth name, and simultaneously scans RSSI signals of the wearable devices, when a detected Bluetooth RSSI signal value is higher than the threshold, the smart phone automatically connects to the wearable device.

Based on the above method embodiment, the present invention further provides a Bluetooth-based system for automatic connection between a wearable device and a mobile terminal, as shown in FIG. 5, the Bluetooth-based system for automatic connection between a wearable device and a mobile terminal comprising:

A Bluetooth advertising module 100 configured for a wearable device to advertise a Bluetooth name via Bluetooth;

A scanning module 200 configured for a smart terminal to scan to acquire the Bluetooth name of the wearable device, and when the Bluetooth name exists in a Bluetooth name list pre-written into the smart terminal, to write the Bluetooth name of the wearable device into a scan list.

Furthermore, as shown in FIG. 5, the Bluetooth-based system for automatic connection between a wearable device and a mobile terminal further comprises:

A Bluetooth connection module 300 configured for a smart terminal to acquire a current Bluetooth received signal strength indication value that corresponds to each wearable device in the scan list, and if the current Bluetooth received signal strength indication value of a wearable device is higher than a preset Bluetooth received signal strength indication threshold, to establish a Bluetooth connection with the corresponding wearable device.

Furthermore, in the Bluetooth-based system for automatic connection between a wearable device and a mobile terminal, the wearable device in the Bluetooth advertising module advertises a Bluetooth name in a Bluetooth mode or a Bluetooth Low Energy mode and transmits a Bluetooth signal; wherein the Bluetooth mode is a mode that supports Bluetooth 2.0, Bluetooth 2.1 or Bluetooth 3.0; the Bluetooth Low Energy mode is a mode that supports Bluetooth Smart.

Furthermore, in the Bluetooth-based system for automatic connection between a wearable device and a mobile terminal, the scanning module 200 further comprises a mobile terminal detecting current Bluetooth received signal strength indication values of the Bluetooth signals transmitted by the wearable devices that have been written into the scan list.

Furthermore, in the Bluetooth-based system for automatic connection between a wearable device and a mobile terminal, the Bluetooth received signal strength indication threshold is −30 dBm.

In summary, the present invention provides a Bluetooth-based method and system for automatic connection between a wearable device and a mobile terminal, the method comprising: the wearable device advertises a Bluetooth name via Bluetooth; the smart terminal scans to acquire the Bluetooth name of the wearable device, and when the Bluetooth name exists in a Bluetooth name list pre-written into the smart terminal, writes the Bluetooth name of the wearable device into a scan list. When the wearable device is placed in a specific area of the smart terminal, the wearable device can be automatically connected, which not only has a convenient operation, but also ensures security.

The above Bluetooth-based system for automatic connection between a wearable device and a mobile terminal and the Bluetooth-based method for automatic connection between a wearable device and a mobile terminal in the above embodiment belong to the same concept, and any method according to the embodiment of the Bluetooth-based method for automatic connection between a wearable device and a mobile terminal can be run on the Bluetooth-based system for automatic connection between a wearable device and a mobile terminal. Please see the embodiment of the Bluetooth-based method for automatic connection between a wearable device and a mobile terminal for specific implementation processes thereof, which will not be repeated herein.

It should be noted that, with respect to the Bluetooth-based method for automatic connection between a wearable device and a mobile terminal in embodiments of the present invention, those skilled in the art may understand that all or a part of the flows of to the Bluetooth-based method for automatic connection between a wearable device and a mobile terminal in embodiments of the present invention may be implemented through a computer program by controlling relevant hardware, the computer program may be stored in a computer-readable storage medium, e.g. stored in a memory of a mobile terminal and executed by at least one processor inside the mobile terminal, and the execution process may include flows of embodiments of the above methods. Wherein, the storage medium may be magnetic disk, compact disc, Read Only Memory (ROM) or Random Access Memory (RAM).

With respect to the Bluetooth-based system for automatic connection between a wearable device and a mobile terminal in embodiments of the present invention, all functional modules thereof may be integrated in a processing chip, or each module may be physically separate, or two or more modules are integrated in one module. The above integrated modules may be implemented either in the form of hardware or in the form of software functional modules. If the integrated modules are implemented in the form of software functional modules and sold or used as independent products, they may also be stored in a computer-readable storage medium, and the storage medium is, for example, Read Only Memory, magnetic disk or compact disc.

It should be understood that applications of the present invention are not limited to the above examples. For those skilled in the art, improvement or variation may be made according to the description above, and all these improvements or variations shall be encompassed by the appended claims of the present invention.

1. A Bluetooth-based method for automatic connection between a wearable device and a mobile terminal, wherein the method comprises:
The wearable device advertises a Bluetooth name via Bluetooth;
The mobile terminal scans to acquire the Bluetooth name of the wearable device, and when the Bluetooth name exists in a Bluetooth name list pre-written into the mobile terminal, the mobile terminal writes the Bluetooth name of the wearable device into a scan list;
Detecting current Bluetooth received signal strength indication (RSSI) values of Bluetooth signals transmitted by wearable devices that have been written into the scan list;
The mobile terminal acquires a current Bluetooth RSSI value for each of the wearable devices in the scan list, and if the current Bluetooth RSSI value of each of the wearable devices in the scan list is higher than a preset Bluetooth RSSI threshold, the mobile terminal establishes a Bluetooth connection with a corresponding wearable device of the wearable devices in the scan list.

2. The method of claim 1, wherein the wearable device advertises the Bluetooth name in a Bluetooth mode and transmits a Bluetooth signal; wherein the Bluetooth mode is a mode that supports Bluetooth 2.0, Bluetooth 2.1 or Bluetooth 3.0.

3. The method of claim 1, wherein the wearable device advertises the Bluetooth name in a Bluetooth Low Energy mode and transmits a Bluetooth signal; wherein the Bluetooth Low Energy mode is a mode that supports Bluetooth Smart.

4. The method of claim 1, wherein the Bluetooth RSSI threshold is −30 dBm.

5. A Bluetooth-based method for automatic connection between a wearable device and a mobile terminal, wherein the method comprises:
The wearable device advertises a Bluetooth name via Bluetooth;
The mobile terminal scans to acquire the Bluetooth name of the wearable device, and when the Bluetooth name exists in a Bluetooth name list pre-written into the mobile terminal, the mobile terminal writes the Bluetooth name of the wearable device into a scan list.

6. The method of claim 5, further comprising:
The mobile terminal acquires a current Bluetooth RSSI value for each wearable device in the scan list, and if the current Bluetooth RSSI value of each of the wearable device in the scan list is higher than a preset Bluetooth RSSI threshold, the mobile terminal establishes a Bluetooth connection with a corresponding wearable device in the scan list.

7. The method of claim 5, wherein the wearable device advertises the Bluetooth name in a Bluetooth mode and transmits a Bluetooth signal; wherein the Bluetooth mode is a mode that supports Bluetooth 2.0, Bluetooth 2.1 or Bluetooth 3.0.

8. The method of claim 5, wherein the wearable device advertises the Bluetooth name in a Bluetooth Low Energy mode and transmits a Bluetooth signal; wherein the Bluetooth Low Energy mode is a mode that supports Bluetooth Smart.

9. The method of claim 6, further comprising:
Detecting current Bluetooth RSSI values of the Bluetooth signals transmitted by wearable devices that have been written into the scan list.

10. The method of claim 6, wherein the Bluetooth RSSI threshold is −30 dBm.

11. A Bluetooth-based system for automatic connection between a wearable device and a mobile terminal, wherein the system comprises one or more modules configured to:
cause a wearable device to advertise a Bluetooth name via Bluetooth;
cause a mobile terminal to scan to acquire the Bluetooth name of the wearable device, and when the Bluetooth name exists in a Bluetooth name list pre-written into the mobile terminal, the mobile terminal writes the Bluetooth name of the wearable device into a scan list.

12. The system of claim 11, wherein the one or more modules are further configured to:
cause a mobile terminal to acquire a current Bluetooth RSSI value for each wearable device in the scan list, and if the current Bluetooth RSSI value of each of the wearable device in the scan list is higher than a preset Bluetooth RSSI threshold, the mobile terminal establishes a Bluetooth connection with a corresponding wearable device in the scan list.

13. The system of claim 11, wherein the wearable device advertises the Bluetooth name in a Bluetooth mode and transmits a Bluetooth signal; wherein the Bluetooth mode is a mode that supports Bluetooth 2.0, Bluetooth 2.1 or Bluetooth 3.0.

14. The system of claim 11, wherein the wearable device in the Bluetooth advertising module advertises the Bluetooth name in a Bluetooth Low Energy mode and transmits a Bluetooth signal; wherein the Bluetooth Low Energy mode is a mode that supports Bluetooth Smart.

15. The system of claim 12, wherein the one or more modules are further configured to cause the mobile terminal to detect current Bluetooth RSSI values of Bluetooth signals transmitted by wearable devices that have been written into the scan list.

16. The system of claim 12, wherein the Bluetooth RSSI threshold is −30 dBm.

17. The method of claim 1, wherein prior to the detecting, the mobile terminal displays a specific area corresponding to the preset Bluetooth RSSI threshold.

18. The method of claim 6, wherein prior to the acquiring, the mobile terminal displays a specific area corresponding to the preset Bluetooth RSSI threshold.

19. The system of claim 12, wherein the one or more modules are further configured to:
display a specific area corresponding to the preset Bluetooth RSSI threshold.

20. The system of claim 19, wherein the specific area is a circular area.
